(19) United States
(12) Patent Application Publication
(10) Pub. No.: US 2014/0150899 A1
(43) Pub. Date: Jun. 5, 2014

(54) FLUID TRANSFER PROTECTION SLEEVE

(71) Applicant: JERRY PUCKETT, FAIR OAKS RANCH, TX (US)

(72) Inventor: JERRY PUCKETT, FAIR OAKS RANCH, TX (US)

(21) Appl. No.: 13/691,301

(22) Filed: Nov. 30, 2012

(51) Int. Cl. F17D 1/08; F16L 55/00

(52) U.S. Cl. CPC F17D 1/08; F16L 55/00
USPC 137/375; 137/565.01

(57) ABSTRACT

The present invention is designed to prevent damage to lined ponds during removal and placement of a suction/discharge hose. The fluid transfer protection sleeve is a conduit with a liquid port on one end and a hose port on the opposing end. The fluid transfer protection sleeve is comprised of an angled section, a vented body, and a solid walled section that are connected to create an interior channel from the hose port to the liquid port. The liquid port is located on the angled section. Upon insertion of the hose into hose port, the liquid is drawn in (or out) through the liquid port and vents, thus drawing (or discharging) water away from the bottom of the pond. Furthermore, the interior channel prevents the hose from coming into contact with liner and thus preventing damage.

### CROSS-REFERENCES TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates to the process of transferring fluid, namely water, to and from a pond. More specifically, the present invention provides a safer way to pump fluid in and out of a frac pond without rupturing or damaging the protective lining of the frac pond while maintaining industry standard flow rates.

2. Description of the Related Art

In the oil and gas industry, fracturing (“fracking”) is commonly used to stimulate wells to produce more hydrocarbons. The process of fracking requires the use of substantial amounts of water that can lead to pollution and water waste. To reduce water waste, frac ponds are constructed near well site(s) for storing and reusing water related to fracking operations. However, once water is used in a fracking operation, it may become environmentally unsafe due to additions of chemicals utilized in the fracking process. To prevent seepage of the frac water into the surrounding soil, frac ponds are lined with plastic to create an impervious barrier preventing soil contamination. Typical liners are made of plastic with a thickness of twelve to forty mil. The plastic is sufficiently sturdy to prevent any leaks or holes from forming

Water is pumped to and from a frac pond to a receiving tank. The receiving tank may be mobile and located on tanker truck or stationary and located adjacent a well site. Water is generally transferred directly to a stationary receiving tank through a series of pipes connected to a high capacity stationary pump located adjacent to the frac pond. Water may be transferred to a mobile receiving tank through a pump mounted on a tanker truck or through a high capacity stationary pump.

Tanker trucks vary in size and capacity but most include a receiving tank, truck mounted hose, and a small capacity pump capable of pumping fluid at a rate of one hundred gallons per minute. A typical hose utilized on a tanker truck is flexible and ranges in diameter from four to eight inches. A typical hose has connectors at each opposing end allowing for connection to standard tanker trucks and pumps. These connectors are generally made of metal as they have to be sufficiently strong to maintain connection to pumps at high flow rates.

To operate a tanker truck fluid transfer, the crew physically places the tanker truck hose directly into the frac pond with the other end of hose connected to the pump located on the tanker truck. In a standard tanker truck, fluid flows from the hose into the pump where it is discharged into the receiving tank through a discharge pipe or other suitable means. Generally, the hose, and its heavy duty connector, rests on the bottom of the frac pond resulting in direct physical contact with the frac pond liner. During the suction/discharge of the fluid from the tanker truck hose, the fluid exits or enters the end of the hose at a singular location creating substantial pressure forces. The entry point of the hose is generally directly adjacent to the liner, which may result in damage to the liner depending on the strength of the suction or discharge.

When the desired amount of fluid is transferred, the crew drags the hose out of the frac pond for storage back on the tanker truck. However, if the crew is not careful, the heavy duty metal connector on the hose may drag along the frac pond liner. If done egregiously or over a sufficient period of time, the frac pond liner may develop a hole allowing contaminated water to escape the frac pond and potentially contaminate the soil and underground aquifers. In these situations it is difficult to know when a hole in the liner has occurred until after contamination has resulted. To fix the frac pond liner, a dive team must enter the frac pond to repair the hole. This exposes the diver to potentially hazardous chemicals and creates additional expense to the operator of the frac pond.

The second method of frac water transfer involves the use of a high capacity stationary pump located on or near the bank of the frac pond. This method utilizes a supply hose that connects the high capacity stationary pump to the supply of water in the frac pond and a second hose/conduit that connects the high capacity stationary pump to the receiving tank. The second hose/conduit may simply be the tanker truck hose to connect to the mobile receiving tank or a series of pipes connected to a stationary receiving tank.

Similar to the tank truck hoses, the supply hose has connectors at each opposing end. These connectors are generally made of metal as they have to be sufficiently strong to maintain connection to pumps at high flow rates. A stationary high capacity pump may transfer fifty barrels of liquid per minute. In this method, a crew pumping water to or from the frac pond does not physically interact with the frac pond and is less likely to damage the liner because the tanker truck hose does not come into contact with the frac pond.

The use of a stationary high capacity pump results in a permanently installed supply hose within the frac pond. When this occurs, a system of flotation devices and overhead cables are installed to keep the hose partially suspended in the air to keep the hose from resting on the bottom of the frac pond. However, this system increases the overall construction costs of the frac pond by requiring professional design and additional materials. Due to the increased complexity of design and construction, frac ponds utilizing this system take longer to become operationally ready which may result in drilling or fracking delays. Once installed, the system must be appropriately maintained and modified as the volume of water from the frac pond fluctuates. Furthermore, operators of the frac pond require full time staff to operate the pump or provide training to the frac crews to ensure safety and proper operation of the high capacity stationary pump. If the high capacity stationary pump or the hose requires maintenance, then frac crews would have to revert to the above described method of placing the hose directly into the frac pond to rest on the liner.

The present invention is intended to be compatible for use with stationary receiving tanks and mobile receiving tanks such as tanker trucks as well as use of stationary high capacity pumps or pumps located on tanker trucks.

### BRIEF SUMMARY OF THE INVENTION

The present invention is designed to prevent damage to the liner that occurs during removal and placement of a suction/discharge hose and may be used in conjunction with a permanently installed suction/discharge hose or with the removable tanker truck suction/discharge hose. The fluid transfer protection sleeve is a pipe with a liquid port on one end and a hose port on the opposing end. The fluid transfer protection sleeve is comprised of an angled section, a vented body, and a solid walled section that are connected to create an interior channel from the hose port to the liquid port.

The fluid transfer protection sleeve extends into a body of water that is lined with a material impervious to water. The solid walled section generally resides outside the water and contains the hose port. The angled section resides at or near the bottom of the body of water with the angled liquid port oriented away from the bottom of the body of water. The vented section resides between the angled section and the solid walled section and contains a plurality of vents. These vents are oriented away from the liner in the same direction as the liquid port. To prevent unintended suction of air into the suction/discharge hose, the vented portion preferably remains submerged at all times. Once submerged, the frac pond water enters the fluid transfer protection sleeve to achieve the same equilibrium level as the water in the frac pond.

In operation, a suction/discharge hose is lowered into the fluid transfer protection sleeve through the hose port. The hose remains within the interior channel of the fluid transfer protection sleeve and may be positioned anywhere within the vented body. The opposing end of the hose, located outside the fluid transfer protection sleeve, is connected to a pump. The pump controls whether fluid is suctioned into the hose or discharged out of the hose. When suction is called for, a suction force is created at the end of the hose located within the vented body of the fluid transfer protection sleeve. Fluid then enters through the liquid port, through a screen, and into the interior channel of fluid transfer protection sleeve until it reaches the hose. The suction force also causes fluid to enter the fluid transfer protection sleeve through the vents, ensuring the proper volume of fluid is available to the suction hose based on the capacity of the pump. Fluid then flows through the hose, via the pump, and into a receiving tank. The receiving tank may be stationary or located on a tanker truck.

Importantly, due to the liquid port being larger than the hose and the additional intake of fluid from the vents, the suction pressures occurring at the liquid port are less than those located at the entry point of the hose. Thus, the same amount of fluid may enter the hose without the same substantial suction forces occurring at the liquid port. This reduction of suction force helps alleviate damage to the plastic liner. Furthermore, the angle of the liquid port and vents causes the suction forces to be oriented away from the plastic liner. The combination of the larger diameter of the liquid port and the angle of the liquid port and vents alleviates the suction force that interacts with the liner of the frac pond, thus reducing damage to the liner.

For discharge, fluid from the receiving tank is suctioned, via the pump, into the hose where the fluid exits the hose and enters the interior channel of the fluid transfer protection sleeve. The fluid is then discharged out of the fluid transfer protection sleeve through the liquid port, and to some extent, the vents. Similarly to the suction forces described above, the combination of the larger diameter of the liquid port and angle of the liquid port and vents alleviates the discharge forces interacting with the liner of the frac pond which reduces damage to the liner.

Once the operation is completed, the hose is removed by sliding it out of the fluid transfer protection sleeve. Through the use of the sleeve, the hose and connector, never physically interact with the liner.

### BRIEF DESCRIPTION OF THE FIGURES

FIG. 1 is an angled side view of the preferred embodiment of the fluid transfer protection sleeve.

FIG. 2 is an exploded view the preferred embodiment of the fluid transfer protection sleeve.

FIG. 3 is a profile view of the preferred embodiment of the fluid transfer protection sleeve system.

### DETAILED DESCRIPTION OF VARIOUS EMBODIMENTS

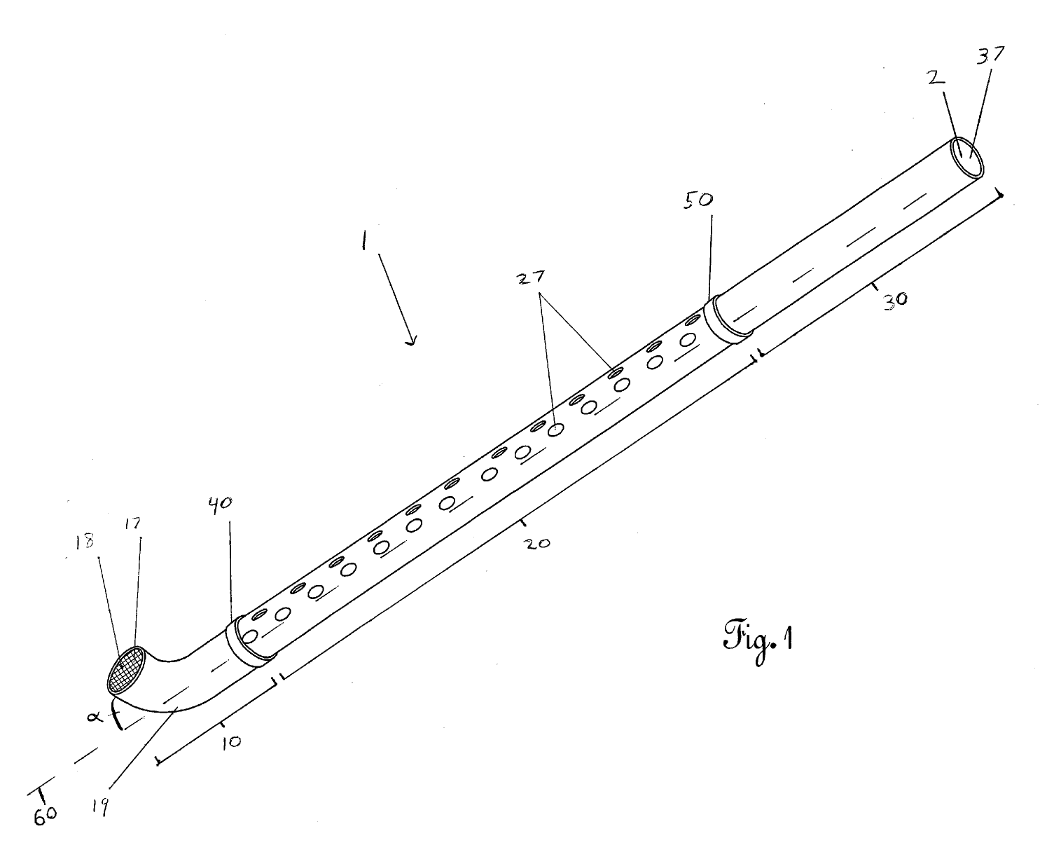

FIG. 1 is an angled side view of the preferred embodiment of the fluid transfer protection sleeve 1. Fluid transfer protection sleeve 1 is a pipe with a liquid port 17 on one end and a hose port 37 on the opposing end. The fluid transfer protection sleeve 1 is comprised of an angled section 10, a vented body 20, and a solid walled section 30 which together define an interior channel 2 between liquid port 17 and hose port 37. In the preferred embodiment, the angled section 10 is connected to one end of the vented body 20 and the solid walled section 30 is connected to the opposing end of vented body 20. First connecting collar 40 is located at the junction of angled section 10 and vented body 20. Second connecting collar 50 is located at the junction of vented body 20 and solid walled section 30.

Angled section 10 has an elbowed bend 19 resulting in an angle a relative to the longitudinal or center axis 60 of the vented body 20 and solid walled section 30. In the preferred embodiment angle a is approximately ninety degrees. Vents 27 are disposed through vented body 20 and are oriented in substantially the same direction as liquid port 17.

In the preferred embodiment, the angled section 10, vented body 20, solid walled section 40, first connecting collar 40, and second connecting collar 50 are cylindrical and made of a substantially rigid material such as polyvinyl chloride (“PVC”). The interior channel 2 is substantially uniform in size from liquid port 17 to hose port 37. It is understood that alternative embodiments exist in that the pipe may have a cross section in a variety of shapes such as square, rectangular or elliptical. In an alternative embodiment featuring a quadrangular shape, the vents are located along the same face of the vented body as the liquid port.

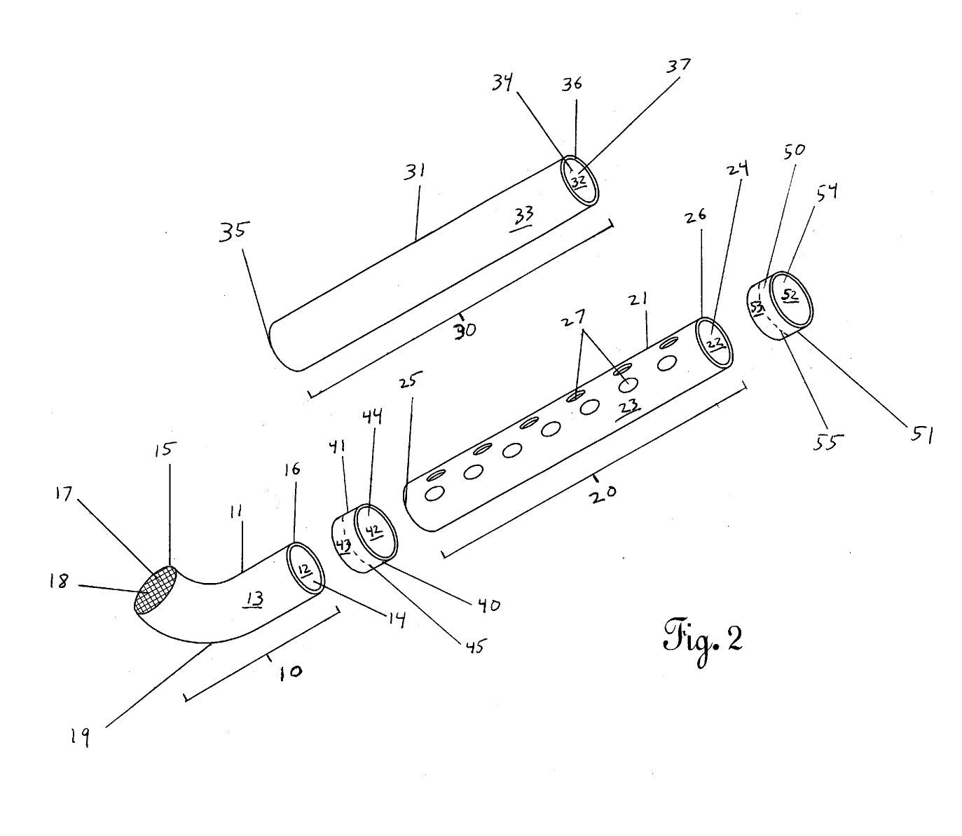

FIG. 2 is an exploded view of the preferred embodiment. Angled section 10 is a hollow cylindrical structure with a sidewall 11 having an inner surface 12 and exterior surface 13. Sidewall 11 defines an interior channel 14. The downward annular end 15 defines a liquid port 17. Screen 18 covers the liquid port 17. Angled section 10 has an elbowed bend 19 between the downward annular end 15 and upward annular end 16. The diameter of the downward annular end 15 and upward annular end 16 are substantially similar. Due to the structure of the elbowed bend 19, the interior channel 14 is not substantially narrowed.

Vented body 20 is a hollow cylindrical structure with a sidewall 21 having an inner surface 22 and exterior surface 23. Sidewall 21 defines an interior channel 24. Vented body 20 has a downward annular end 25 and an upward annular end 26. The diameter of the downward annular end 25 and upward annular end 26 are substantially similar. A plurality of vents 27 are disposed through sidewall 21, along the length of the vented body 20 from the downward annular end 25 to the upward annular end 26. Vents 27 are only located on a portion of the vented body 20 so that the vents 27 are oriented in the substantially the same direction as liquid port 17. In the preferred embodiment, vents 27 are circular in nature with a smaller diameter than the downward annular end 25 and upward annular end 26. The vents 27 create an access point into the interior channel 24. It is understood that alternative embodiments of the vents 27 exist in that they may occur in a variety of shapes and sizes such as squares, rectangles, or slots.

Solid walled section 30 is a hollow cylindrical structure with a sidewall 31 having an inner surface 32 and exterior surface 33. Sidewall 31 defines an interior channel 34. Solid walled section 30 has a downward annular end 35 and an upward annular end 36. The upward annular end 36 defines a hose port 37. The diameter of the downward annular end 35 and upward annular end 36 are substantially similar.

Angled section 10, vented body 20, and solid walled section 30 are made of substantially the same dimensions in reference to the interior channel. Sidewalls 11, 21, and 31 have substantially the same inner and outer diameters. The annular ends 15, 16, 25, 26, 35, 36 are substantially equal. Thus, interior channels 14, 24, 34 combine to form a substantially uniform sized channel 2. In the preferred embodiment, the inner diameter is sixteen inches, or of sufficient diameter to accommodate standard hoses utilized as suction/discharge lines.

First connecting collar 40 is a hollow cylindrical structure with a sidewall 41 having an inner surface 42 and exterior surface 43. Sidewall 41 defines an interior channel 44. The inner diameter of sidewall 41 is sufficiently larger than the outer diameter of angled section's 10 sidewall 11 and vented body's 20 sidewall 21. This allows inner surface 42 to frictionally engage the angled section's 10 outer surface 13 and vented body's 20 outer surface 23.

Connection of the angled section 10 and vented body 20, via the first connecting collar 40, is well known in the art for connecting two identical diameter PVC pipes together. Adhesive may be applied to the inner surface 42 of the first connecting collar 40. Adhesive is placed on the outer surface 13 of the angled section 10, adjacent to the upward annular end 16. Adhesive is placed on the outer surface 23 of the vented body 20, adjacent to the downward annular end 25. Once adhesive is applied, the upward annular end 16 of angled section 10 is pushed into the first connecting collar 40 until it reaches half-way point 45. The downward annular end 25 of vented body 20 is pushed into the opposite portion of the first connecting collar 40 from angled section 10, until it reaches the upward annular end 16 of angled section 10. Angled section 10 and vented body 20 are held together through frictional force and adhesive.

Second connecting collar 50 is a hollow cylindrical structure with a sidewall 51 having an inner surface 52 and exterior surface 53. Sidewall 51 defines an interior channel 54. The inner diameter of sidewall 51 is sufficiently larger than the outer diameter of vented body's 20 sidewall 21 and solid walled section's 30 sidewall 31. This allows inner surface 42 to frictionally engage vented body's 20 outer surface 23 and solid walled section's 30 outer surface 33.

Connection of the vented body 20 and solid walled section 30, via the second connecting collar 50, is well known in the art for connecting two identical diameter PVC pipes together. Adhesive may be applied to the inner surface 52 of the second connecting collar 50. Adhesive is placed on the outer surface 23 of the vented body 20 adjacent to the upward annular end 26. Adhesive is placed on the outer surface 33 of solid walled section 30 adjacent to the downward annular end 35. Once adhesive is applied, the upward annular end 26 of vented body 20 is pushed into the second connecting collar 50 until it reaches half-way point 55. The downward annular end 35 of solid walled section 30 is pushed into the opposite portion of the second connecting collar 50 from vented body 20 until it reaches the upward annular end 26 of vented body 20. Vented body 20 and solid walled section 30 are held together through frictional force and adhesive.

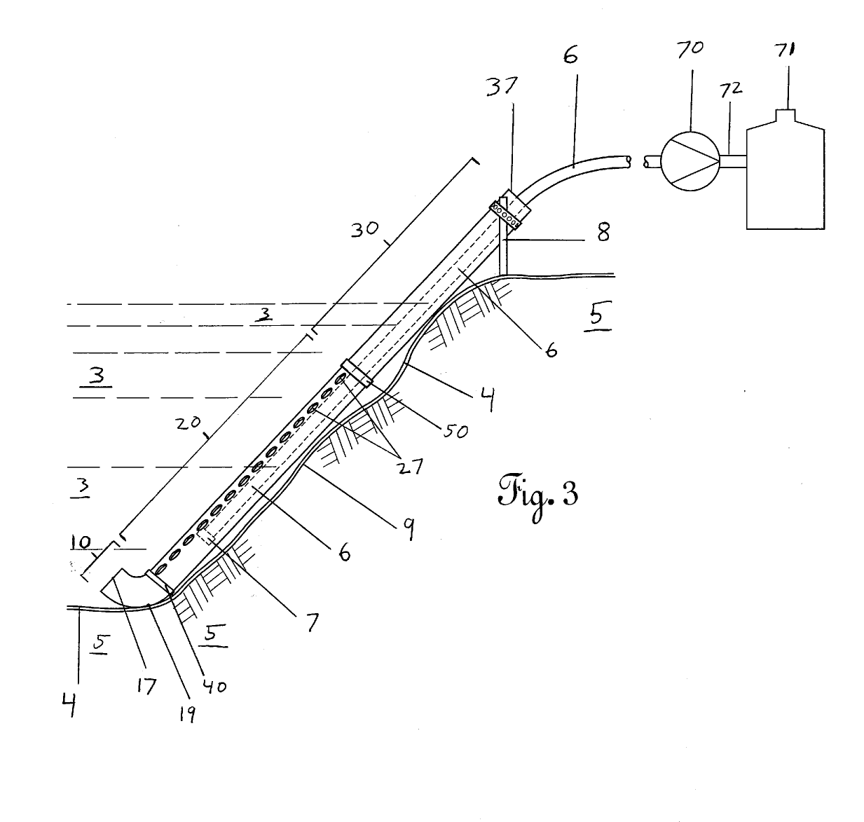

FIG. 3 discloses the preferred embodiment in operation. Fluid transfer protection sleeve 1 is positioned along the edge of a body of water 3, where the fluid transfer protection sleeve 1 rests on liner 4. Liner 4 lines the body of water 3 creating an impervious barrier preventing water from seeping into the surrounding land 5. Angled section 10 and liquid port 17 are positioned away from the bottom of the water, thus away from the liner 4. Typically, but not mandatory, the elbowed bend 19 rests on the bottom of the frac pond. Vents 27 are positioned away from the sidewall 9 of the body of water 3. An equilibrium of water is established between the inner channel 2 of the fluid transfer protection sleeve 1 and the body of water 3.

Stand 8 is mounted in the surrounding land 5 outside the body of water 3. Stand 8 is connected to the fluid transfer protection sleeve 1 near the upward annular end 36 of the solid walled section 30. Connection may occur through a number of different connection means such as rope, bungee cord, or chain tied around, or through, the sidewall of fluid transfer protection sleeve and mounted to the stand 8. Connection may also occur through anchors disposed through the sidewall 31 of the solid walled section 30 into the stand 8. Connection may also occur through the use of a PVC fitted collar. Connection of the fluid transfer protection sleeve 1 inhibits movement and prevents the fluid transfer protection sleeve 1 from sliding into the body of water. The connection also allows for control of how deep the fluid transfer protection sleeve is within the body of water 3. In the preferred embodiment the vented body 20 is positioned within the water at all times as to prevent influx of air into the interior channel 2.

Adjacent to the body of water 3 is pump 70 which is connected to receiving tank 71 via a connection means 72. It is understood pump 70 may be a stationary pump or pump located on a tanker truck. It is understood receiving tank 71 may be stationary or part of a tanker truck. Connection means 72 may occur through a number of commonly known mechanisms depending on the location of the receiving tank and whether the pump and receiving tank are located on a tanker truck. For example, if pump 70 and receiving tank 71 are located on a tanker truck, connection means 72 may be a discharge pipe or a hose. If the receiving tank is located some distance away from the body of water 3, connection means 72 may be a series of pipes.

In operation, hose 6 extends from pump 70 into interior channel 2 of fluid transfer protection sleeve 1 through hose port 37. Hose 6 has a connector 7 on the end disposed into the fluid transfer protection sleeve 1. Hose 6 may be extended all the way to the elbowed bend 19 but should not exit the liquid port 17 of fluid transfer protection sleeve 1. When pump 70 is activated to draw liquid in, a suction force is created in hose 6 near connector 7. Depending on the type of pump, hose 6 may be applying a suction force sufficient to bring in 50 barrels of liquid a minute. This suction force flows through the interior channel 2 and causes fluid to flow from body of water 3 into fluid transfer protection sleeve 1 through liquid port 17. Screen 18 filters the fluid prior to entering interior channel 2. Additionally, fluid from body of water 3 flows through vents 27 into the interior channel 2. From hose 6, the fluid flows to pump 70, through connection means 72, and into receiving tank 71.

Due to liquid port 17 being larger than the entry point of hose 6, and the added entry of fluid from vents 27, the suction pressures occurring at liquid port 17 are less than those located at the entry point of the hose 6. Thus, the same amount of fluid may enter hose 6 without the same substantial suction forces occurring at the liquid port 17. Furthermore, the angle of the liquid port 17 and vents 27 causes the suction forces to be oriented away from the plastic liner 4 located at the bottom of the body of water 3. The combination of the larger diameter of the liquid port 17 and angle of the liquid port 17 and vents 27 alleviates the suction forces interacting with liner 4 of the frac pond which reduces the interaction of suction forces with the liner, thus reducing damage and wear on the liner.

If the operator wishes to discharge fluid from the receiving tank 71, the same process for insertion of the hose 6 as described above, is followed. Once pump 70 is activated for discharge, fluid exits receiving tank 71, through connection means 72, and into hose 6 via pump 70. The discharge of the fluid from hose 6 forces the discharged fluid to move through interior channel 2 where it exits the fluid transfer protection sleeve 1 through liquid port 17 and vents 27 which directs fluid away from sidewall 9 and liner 4. Similarly to the suction forces described above, the combination of the larger diameter of liquid port 17 and angle of liquid port 17 and vents 27, alleviate the discharge forces interacting with liner 4 of the frac pond which reduces damage to liner 4. Discharge from hose 6 may occur at a rate of fifty barrels per minute, but by the time the fluid reaches liquid port 17, it has slowed substantially due to the increased volume. Thus, the speed of the discharged fluid which likely contains associated particulates, is greatly reduced when it finally, if at all, interacts with the liner 4. Without the use of the fluid protection sleeve 1, discharged fluid and particulates may interact with the liner 4 causing greater wear due to the velocity of the fluid and particulate.

Once the desired amount of fluid is transferred into receiving tank 71, pump 70 is shut off which eliminates the suction or discharge force. If hose 6 is attached to a tanker truck or simply needs to be removed, hose 6 is slid out of the fluid transfer protection sleeve 1 via hose port 37. Through use of the fluid transfer protection sleeve 1, hose 6 and connector 7, never come into physical contact with the liner, thus preventing opportunity for damaging the liner 4.

It is understood liquid port 17 may have angles differing from ninety degrees as described above as long as the angle of the elbowed bend 19 is sufficient to direct forces and liquid away from the liner 4. It is further understood vents 27 may occur in a variety of different numbers, formations, and shapes as long as vents 27 direct fluid and forces away from liner 4.

It is understood the preferred embodiment may be modified to fulfill specific needs of the body of water it is to be utilized for. It is preferable that vented body 20 remains submerged in the body of water. Furthermore, vented body 20 and solid walled section 30 may be incorporated in multiple segments to obtain the desired length. For example, for a deep body of water, it may be necessary to connect two vented body sections via connecting collars with one solid walled section. Moreover, additional angled sections (without liquid ports) may be inserted between vented bodies if necessary to conform to the contours of the body of water.

In an alternative embodiment to standard PVC attachment, the angled section, vented body, and solid walled section may be attached via welding or heat-sealing, thus eliminating the need for adhesive and connecting members. In a further embodiment, it is envisioned that the angled section, vented body, and solid walled section may be integral in part or in whole. For example, the vented body and solid walled section may be one piece with the angled section connected or all three sections may be integral.

In a further embodiment, the fluid protection sleeve consists of only the angled connection and solid walled section. This embodiment may be suitable for lower capacity pumps in which the volume of water available to the supply hose is not a concern.

The present invention is described above in terms of a preferred illustrative embodiment of a specifically-described fluid transfer protection sleeve. Those skilled in the art will recognize that alternative constructions of such an apparatus can be used in carrying out the present invention. Other aspects, features, and advantages of the present invention may be obtained from a study of this disclosure and the drawings, along with the appended claims.

I claim:

1. A fluid transfer protection sleeve comprising:
a conduit comprising a sidewall, a first end defining a first opening, and a second end defining a second opening opposing said first end;
a first section of said conduit that is angled relative to a second section of said conduit;
wherein said first opening is located in said first section.

2. A fluid transfer protection sleeve of claim 1 further comprising at least one vent disposed through said sidewall of said second section.

3. A fluid transfer protection sleeve of claim 2 wherein said at least one vent and said first opening are oriented in substantially the same direction.

4. A fluid transfer protection sleeve of claim 1 further comprising a screen covering said first opening.

5. A fluid transfer protection sleeve of claim 1 wherein said angle is 90 degrees.

6. A fluid transfer protection sleeve of claim 1 wherein said conduit is integral.

7. A fluid transfer protection sleeve of claim 1 wherein said conduit is made of polyvinyl chloride.

8. A fluid transfer system comprising:
a body of water;
a receiving tank outside said body of water;
a pump connected to said receiving tank;
a conduit comprising a sidewall, a first section having a first end defining a first opening wherein said first section is angled relative to a second section of said conduit, said first opening is oriented away from bottom of said body of water, said second section having a second end defining a second opening opposing said first end, and said conduit extending from outside said body of water into said body of water with at least said first section and a portion of said second section located in said body of water; and
a hose connected to said pump wherein said hose is disposed through said second opening of said conduit into said portion of said second section located within said body of water.

9. A fluid transfer system of claim 8 further comprising at least one vent disposed through said sidewall of said second section.

10. A fluid transfer system of claim 9 wherein said at least one vent is oriented away from said bottom of said body of water.

11. A fluid transfer system of claim 9 wherein said at least one vent and said first opening are oriented in substantially the same direction.

12. A fluid transfer system of claim 9 wherein said at least one vent is located in said portion of said second section located within said body of water.

13. A fluid transfer system of claim 8 further comprising a screen covering said first opening.

14. A fluid transfer system of claim 8 further comprising a stand attached to said conduit adjacent to said second opening.

15. A fluid transfer system of claim 14 wherein said stand is mounted outside said body of water.

16. A fluid transfer system of claim 8 wherein said angle is 90 degrees.

17. A fluid transfer system of claim 8 wherein said conduit is integral.

18. A fluid transfer system of claim 8 wherein said conduit is made of polyvinyl chloride.
